(19) United States
(12) Patent Application Publication
(10) Pub. No.: US 2013/0128342 A1
(43) Pub. Date: May 23, 2013

(54) INFRARED REFLECTING SUBSTRATE AND LAMINATED GLASS

(71) Applicant: Asahi Glass Company, Limited, Chiyoda-ku (JP)

(72) Inventors: Kazuhiko MITARAI, Chiyoda-ku (JP); Yuichi Hino, Chiyoda-ku (JP); Tamotsu Morimoto, Chiyoda-ku (JP)

(73) Assignee: Asahi Glass Company, Limited, Chiyoda-ku (JP)

(21) Appl. No.: 13/741,429

(22) Filed: Jan. 15, 2013

Related U.S. Application Data
(63) Continuation of application No. PCT/JP2011/066257, filed on Jul. 15, 2011.

(30) Foreign Application Priority Data
Jul. 16, 2010 (JP) 2010-161275

(51) Int. Cl. G02B 5/20

(52) U.S. Cl. CPC G02B 5/208
USPC 359/359

(57) ABSTRACT

To provide an infrared reflecting substrate, from which a laminated glass with surface having favorable neutral color tone without stimulus color tone is obtained. An infrared reflecting substrate 1 comprises a transparent substrate 2, and an infrared reflecting film 3 having at least 7 layers of a high refractive index dielectric film 3H and a low refractive index dielectric film 3L alternately laminated, formed on one principal surface of the transparent substrate 2. The infrared reflecting film 3 has a first laminate portion having at least 5 layers of dielectric films 311 having a n·d/λ value of 0.44 to 0.55 where the refractive index is n when the thickness is d (nm) and the wavelength is λ (nm), continuously laminated, and a second laminate portion 32 having at least 2 layers of dielectric films having a n·d/λ value of 0.03 to 0.12 continuously laminated.

This application is a continuation of PCT Application No. PCT/JP2011/066257, filed on Jul. 15, 2011, which is based upon and claims the benefit of priority from Japanese Patent Application No. 2010-161275 filed on Jul. 16, 2010. The contents of those applications are incorporated herein by reference in its entirety.

### TECHNICAL FIELD

The present invention relates to an infrared reflecting substrate and a laminated glass. Particularly, it relates to an infrared reflecting substrate from which a laminated glass with a surface having a favorable color tone is obtainable, and a laminated glass using it.

### BACKGROUND ART

Heretofore, as a laminated glass to be used for a windshield of a vehicle and the like, a laminated glass having an infrared reflecting film to block the transmission of infrared rays (heat rays) in the sunlight disposed between a pair of facing glass substrates, to suppress the temperature increase in the room and the cooling load, has been known. An infrared reflecting film is formed on a transparent substrate such as a transparent resin film for example, to constitute an infrared reflecting substrate. As the infrared reflecting film, one having an oxide film and a metal film alternately laminated, or one having a high refractive index dielectric film and a low refractive index dielectric film alternately laminated, may, for example, be known.

Glass for a vehicle, or the like, is required to have high infrared shielding properties, and a high visible light transmittance and high radio wave transmission properties as well. Among the above-described infrared reflecting films, one having an oxide film and a metal film alternately laminated has high infrared shielding properties but does not transmit radio waves, and accordingly, a device utilizing radio waves such as a garage door opener or a mobile phone may not receive or send radio waves in the car interior. Whereas, one having a high refractive index dielectric film and a low refractive index dielectric film alternately laminated, which has no metal film, has favorable radio wave transmission properties.

With respect to the infrared reflecting film having a high refractive index dielectric film and a low refractive index dielectric film alternately laminated, one having a n·d value of from 225 to 350 nm with respect to an infrared light having a wavelength λ within a range of from 900 to 1,400 nm, where the refractive index of the dielectric film is n and the thickness is d, has been known (for example, Patent Document 1). It is disclosed that by such an infrared reflecting film, the visible light transmittance and the reflectance in the near infrared region can be made high.

### PRIOR ART DOCUMENT

### Patent Document

Patent Document 1: JP-A-2007-148330

### DISCLOSURE OF INVENTION

### Technical Problem

As mentioned above, with respect to an infrared reflecting film having a high refractive index dielectric film and a low refractive index dielectric film alternately laminated, it has been known that the visible light transmittance and the reflectance in the near infrared region can be made high by adjusting the n·d value of the dielectric film to be within a predetermined range. However, with respect to one having a high refractive index dielectric film and a low refractive index dielectric film repeatedly laminated in combination with the same thickness, when it is formed into a laminated glass, its surface tends to have a stimulus color tone, for example, it tends to be excessively reddish or bluish, such being practically unfavorable.

The present invention has been made to solve the above problems, and its object is to provide a substrate (hereinafter referred to as an infrared reflecting substrate) comprising a transparent substrate, and an infrared reflecting film having a high refractive index dielectric film and a low refractive index dielectric film formed on the transparent substrate, wherein when it is formed into a laminated glass, its surface has a favorable neutral color tone without a stimulus color tone. Further, the object of the present invention is to provide a laminated glass having a favorable color tone on its surface, using such an infrared reflecting substrate, particularly to provide a laminated glass optimum as a glass for a vehicle.

### Solution to Problem

An infrared reflecting substrate according to a first embodiment of the present invention comprises a transparent substrate, and an infrared reflecting film having at least 7 layers of a high refractive index dielectric film and a low refractive index dielectric film alternately laminated, formed on one main surface of the transparent substrate,

wherein the infrared reflecting film has a first laminate portion having at least 5 layers of a high refractive index dielectric film and a low refractive index dielectric film having a n·d/λ value of from 0.44 to 0.55 where the refractive index is n when the thickness is d (nm) and the wavelength is λ (nm), continuously laminated, and a second laminate portion having at least 2 layers of a high refractive index dielectric film and a low refractive index dielectric film having a n·d/λ value of from 0.03 to 0.12 continuously laminated.

An infrared reflecting substrate according to a second embodiment of the present invention comprises a transparent substrate, a first infrared reflecting film having at least 5 layers of a high refractive index dielectric film and a low refractive index dielectric film alternately laminated, formed on one main surface of the transparent substrate, and a second infrared reflecting film having at least 5 layers of a high refractive index dielectric film and a low refractive index dielectric film alternately laminated, formed on the other main surface of the transparent substrate,

wherein at least one of the first infrared reflecting film and the second infrared reflecting film has a first laminate portion having at least 3 layers of a high refractive index dielectric film and a low refractive index dielectric film having a n·d/λ value of from 0.44 to 0.55 where the refractive index is n when the thickness is d (nm) and the wavelength is λ (nm), alternately laminated, and a second laminate portion having at least 2 layers of a high refractive index dielectric film and a low refractive index dielectric film having a n·d/λ value of from 0.03 to 0.12, continuously laminated.

A laminated glass according to a first embodiment of the present invention comprises a pair of facing glass substrates, an infrared reflecting substrate disposed between the pair of glass substrates, and a pair of bonding layers disposed between the pair of glass substrates and the infrared reflecting substrate, wherein the infrared reflecting substrate is the infrared reflecting substrate according to the first or second embodiment of the present invention, and its transparent substrate is made of a resin film.

A laminated glass according to a second embodiment of the present invention comprises an infrared reflecting substrate having an infrared reflecting film on at least one principal plane, a glass substrate disposed to face the infrared reflecting film side of the infrared reflecting substrate, and a bonding layer disposed between the infrared reflecting substrate and the glass substrate, wherein the infrared reflecting substrate is the infrared reflecting substrate according to the first embodiment of the present invention, and its transparent substrate is made of a glass plate.

### Advantageous Effects of Invention

The infrared reflecting substrate of the present invention comprises an infrared reflecting film having a high refractive index dielectric film and a low refractive index dielectric film alternately laminated, wherein the infrared reflecting film has a first laminate portion having a high refractive index dielectric film and a low refractive index dielectric film having a n·d/λ value of from 0.44 to 0.55 continuously laminated, and a second laminate portion having a high refractive index dielectric film and a low refractive index dielectric film having a n·d/λ value of from 0.03 to 0.12 continuously laminated. According to such an infrared reflecting substrate, when it is formed into a laminated glass, a favorable color tone on its surface can be achieved.

### BRIEF DESCRIPTION OF DRAWINGS

FIG. 1 is a cross-sectional view illustrating one example of an infrared reflecting substrate according to a first embodiment of the present invention.

FIG. 2 is a cross-sectional view illustrating a modified example of an infrared reflecting substrate according to a first embodiment of the present invention.

FIG. 3 is a cross-sectional view illustrating one example of an infrared reflecting substrate according to a second embodiment of the present invention.

FIG. 4 is a cross-sectional view illustrating a modified example of an infrared reflecting substrate according to a second embodiment of the present invention.

FIG. 5 is a cross-sectional view illustrating a modified example of an infrared reflecting substrate according to a second embodiment of the present invention.

FIG. 6 is a cross-sectional view illustrating a modified example of an infrared reflecting substrate according to a second embodiment of the present invention.

FIG. 7 is a cross-sectional illustrating one example of a laminated glass according to a first embodiment of the present invention.

FIG. 8 is a cross-sectional view illustrating a modified example of a laminated glass according to a first embodiment of the present invention.

FIG. 9 is a cross-sectional view illustrating one example of a laminated glass according to a second embodiment of the present invention.

### DESCRIPTION OF EMBODIMENTS

Now, the infrared reflecting substrate of the present invention will be described.

First, the infrared reflecting substrate according to the first embodiment of the present invention will be described.

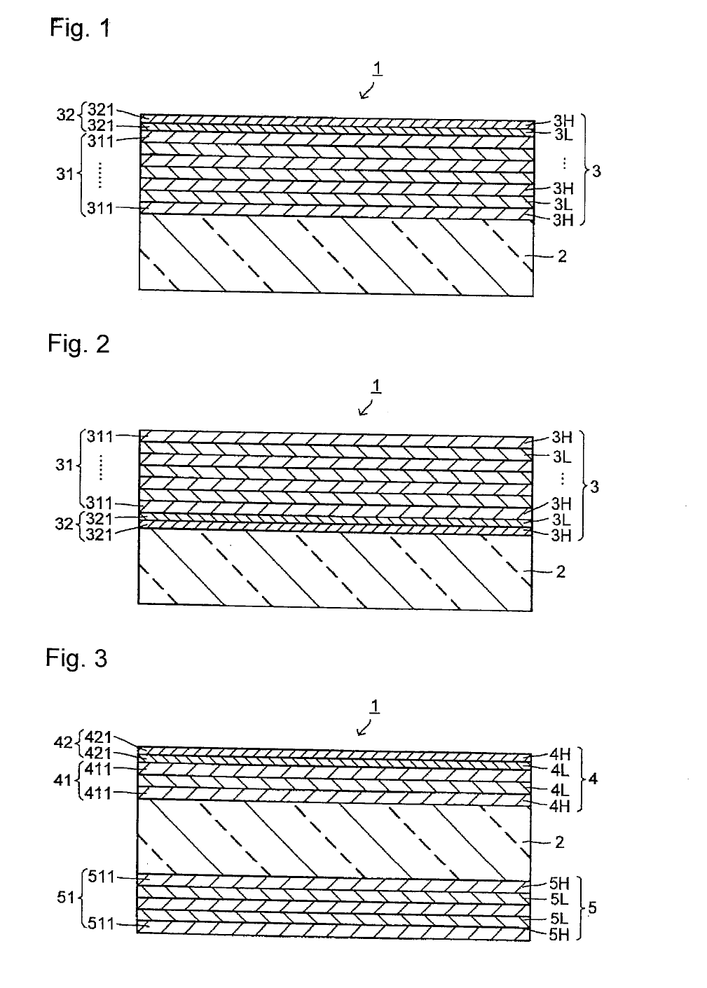

FIG. 1 is a cross-sectional view illustrating one example of the infrared reflecting substrate according to the first embodiment of the present invention.

An infrared reflecting substrate 1 according to the first embodiment comprises a transparent substrate 2, and an infrared reflecting film 3 having at least 7 layers of a high refractive index dielectric film 3H and a low refractive index dielectric film 3L alternately laminated, formed on one main surface of the transparent substrate 2. The infrared reflecting film 3 shown in FIG. 1 has totally 9 layers of the dielectric films 3H and the dielectric films 3L.

This infrared reflecting film 3 has a first laminate portion having at least 5 layers of dielectric films 311 (consisting of the high refractive index dielectric film 3H and the low refractive index dielectric film 3L) having a n·d/λ value of from 0.44 to 0.55 where the refractive index is n when the thickness is d (nm) and the wavelength is λ (nm), continuously laminated, and a second laminate portion 32 having at least 2 layers of dielectric films 321 (consisting of the high refractive index dielectric film 3H and the low refractive index dielectric film 3L) having a n·d/λ value of from 0.03 to 0.12 continuously laminated. Here, “continuously” in “having a plurality of dielectric films consisting of a high refractive index dielectric film and a low refractive index dielectric films continuously laminated” means that the high refractive index dielectric film and the low refractive index dielectric film are laminated without no interlayer.

With respect to the lamination order of the first laminate portion 31 and the second laminate portion 32, the first laminate portion 31 may be disposed on one main surface side of the transparent substrate 2, and the second laminate portion 32 is disposed thereon, as shown in FIG. 1, or the second laminate portion 32 may be disposed on one main surface side of the transparent substrate 2, and the first laminate portion 31 is disposed thereon, as shown in FIG. 2. Further, on the surface of the infrared reflecting film 3, a layer having another function such as a protective layer may be formed. Further, in the infrared reflecting film 3, the dielectric film directly on the transparent substrate 2 side is not necessarily the high refractive index dielectric film 3H, as shown in FIGS. 1 and 2.

The infrared reflecting film 3 is to selectively reflect light in the infrared region (wavelength region: from 780 nm to 1,000 nm) utilizing the interference of light, and as shown in FIGS. 1 and 2, it is constituted by totally at least 7 layers of the high refractive index dielectric film 3H and the low refractive index dielectric film 3L laminated. If the total number of layers of the dielectric films 3H and 3L is less than 7, the visible light transmittance of the reflectance in the near infrared region when formed into a laminated glass may be insufficient.

The number of layers of the dielectric films 3H and 3L is not necessarily limited so long as it is at least 7, however, if it exceeds 13, a decrease in the productivity due to an increase in the production steps tends to be remarkable, and accordingly, with a view to satisfying both the optical properties and the productivity, it is usually preferably from 7 to 13, more preferably from 7 to 11, further preferably from 7 to 9.

The first laminate portion 31 mainly constitutes the infrared reflecting film 3, and is provided to obtain favorable optical properties when formed into a laminated glass. The first laminate portion 31 is constituted by at least 5 layers of the dielectric films 311 consisting of the high refractive index dielectric film and the low refractive index dielectric film having a n·d/λ value of from 0.44 to 0.55 continuously laminated. The respective dielectric films 311 may have different n·d/λ values, but usually, the dielectric films 3H, and the dielectric films 3L, respectively have the same or substantially the same n·d/λ value.

If the n·d/λ value of the dielectric films 311 is less than 0.44 or exceeds 0.55, the visible light transmittance or the reflectance in the near infrared region when formed into a laminated glass may be insufficient. The n·d/λ value of the dielectric films 311 is preferably from 0.44 to 0.53, more preferably from 0.45 to 0.52. Further, also if the number of layers of the dielectric films 311 is less than 5, the visible light transmittance or the reflectance in the near infrared region when formed into a laminated glass may be insufficient.

On the other hand, the second laminate portion 32 is provided mainly to make the color tone of the surface when formed into a laminated glass favorable. The second laminate portion 32 is constituted by 2 layers of the dielectric films 321 consisting of the high refractive index dielectric film and the low refractive index dielectric film having a n·d/λ value of from 0.03 to 0.12 continuously laminated. The respective dielectric films 321 may also have different n·d/λ values.

If the n·d/λ value of the dielectric films 321 is less than 0.03 or exceeds 0.12, when formed into a laminated glass, its surface may have an excessively reddish stimulus color tone. The n·d/λ value of the dielectric films 321 is preferably from 0.03 to 0.11, more preferably from 0.04 to 0.10. If the number of layers of the dielectric films 321 is less than 2, when formed into a laminated glass, its surface may have an excessively reddish stimulus color tone. On the other hand, if the number of layers of the dielectric films 321 exceeds 2, when formed into a laminated glass, the color tone on its surface will not be influenced, however, the increase in the number of layers will lead to a decrease in the productivity.

As mentioned above, by the infrared reflecting film 3 having the first laminate portion 31 and the second laminate portion 32, favorable optical properties and color tone will be obtained when formed into a laminated glass. Further, by such an infrared reflecting film 3, the optical properties can be achieved mainly by the first laminate portion 31, and the color tone on the surface can be achieved mainly by the second laminate portion 32, and accordingly, the film thickness can be designed individually since the respective functions are separated. Accordingly, a substantial change in the film thickness design from the conventional design can be suppressed, whereby a favorable productivity can be achieved.

Here, the n·d/λ value is obtained by dividing the product of the refractive index n and the thickness d by the wavelength λ, so as to be an index independent of the wavelength λ, as the refractive index n of a dielectric film usually varies depending on the wavelength λ. As the n·d/λ value is constant independent of the wavelength λ, in the present invention, a predetermined n·d/λ value should be achieved with at least one wavelength λ. Such a wavelength λ is not particularly limited but is usually one wavelength λ within a range of from 200 to 2,100 nm. More typically, the wavelength λ may be from 300 to 1,200 nm.

The n·d/λ values of the dielectric films 311 and 321 can be adjusted mainly by changing the thickness d. For example, the n·d/λ value of the dielectric films 321 can be made smaller than the n·d/λ value of the dielectric films 311, by making the dielectric films 321 as a whole thinner than the dielectric films 311. Further, the n·d/λ value of the dielectric films 3H and the n·d/λ values of the dielectric films 3L can be made to be the same, by making the dielectric films 3H as a whole thinner than the dielectric films 3L.

Specifically, the thickness of the high refractive index dielectric film 3H among the dielectric films 311 in the first laminate portion is preferably from 90 to 115 nm, more preferably from 90 to 110 nm, although it slightly varies depending upon the refractive index. Further, the thickness of the low refractive index dielectric film 3L is preferably from 150 to 195 nm, more preferably from 155 to 190 nm. By such a thickness, the n·d/λ value of the dielectric films 311 is likely to be adjusted to be from 0.44 to 0.55.

On the other hand, the thickness of the high refractive index dielectric film 3H among the dielectric films 321 in the second laminate portion is preferably from 5 to 30 nm, more preferably from 5 to 25 nm, although it slightly varies depending upon the refractive index. Further, the thickness of the low refractive index dielectric film 3L is preferably from 10 to 50 nm, more preferably from 15 to 45 nm. By such a thickness, the n·d/λ value of the dielectric films 321 is likely to be adjusted to be from 0.03 to 0.12.

The dielectric film 3H is made of a dielectric substance having a refractive index (a refractive index at a wavelength of 550 nm, the same applies hereinafter) of at least 1.9, preferably from 1.9 to 2.5, and is preferably one made at least one member selected from high refractive index dielectric materials such as niobium oxide, tantalum oxide, titanium oxide, zirconium oxide and hafnium oxide.

On the other hand, the dielectric film 3L is made of a dielectric substance having a refractive index of at most 1.5, preferably from 1.2 to 1.5, and is preferably one made of at least one member selected from low refractive index dielectric materials such as silicon oxide and magnesium fluoride.

Such an infrared reflecting film 3 can be formed by a known film formation method, such as a magnetron sputtering method, an electron beam deposition method, a vacuum deposition method or a chemical deposition method. Further, the n·d/λ value can be adjusted mainly by adjusting the film formation time, and specifically, by adjusting the thickness to be within the above-mentioned thickness by the film formation time.

The transparent substrate 2 may be a transparent resin film made of polycarbonate, polymethyl methacrylate (PMMA), polyethylene terephthalate (PET), polyethylene naphthalate (PEN), polyimide, polyethersulfone, polyarylate, nylon, a cycloolefin polymer or the like. Among them, polyethylene terephthalate (PET) can suitably be used, which is relatively strong, whereby the damage when a laminated glass is produced is likely to be suppressed. The transparent substrate in this specification includes a film-form transparent substrate.

The thickness of the transparent resin film is not necessarily limited, but is preferably from 5 to 200 μm, more preferably from 10 to 100 μm. When the thickness of the transparent resin film is at least 5 μm, the film is less likely to have creases with a certain level of rigidity, and deformation by heat when the infrared reflecting film 3 is formed is likely to be suppressed. Further, when it is at most 200 μm, favorable forming properties are achieved, and when formed into a laminated glass, the air line (a defect caused by the air included in the film edge portion, which cannot be removed and looks like a white line) at the edge portion is likely to be suppressed.

Further, as the transparent substrate 2, a known glass plate may be used, such as an inorganic transparent glass plate such as a clear glass plate, a green glass plate or a UV green glass plate (ultraviolet absorbing green glass plate), or an organic transparent glass plate such as a polycarbonate plate or a polymethyl methacrylate plate. The transparent substrate 2 is preferably a glass plate, whereby a laminated glass will easily be obtained for example by disposing another glass plate so that they face each other.

Now, the infrared reflecting substrate according to the second embodiment of the present invention will be described.

FIG. 3 is a cross-sectional view illustrating one example of the infrared reflecting substrate according to the second embodiment of the present invention.

An infrared reflecting substrate 1 according to the second embodiment comprises a transparent substrate 2, a first infrared reflecting film 4 having at least 5 layers of a high refractive index dielectric film 4H and a low refractive index dielectric film 4L alternately laminated, formed on one main surface of the transparent substrate 2, and a second infrared reflecting film 5 having at least 5 layers of a high refractive index dielectric film 5H and a low refractive index dielectric film 5L alternately laminated, formed on the other main surface of the transparent substrate 2.

The infrared reflecting substrate 1 according to the second embodiment is characterized in that the first infrared reflecting film 4 for example has a first laminate portion 41 having at least 3 layers of dielectric films 411 (consisting of a high refractive index dielectric film 4H and a low refractive index dielectric film 4L) having a n·d/λ value of from 0.44 to 0.55 where the refractive index is n when the thickness is d (nm) and the wavelength is λ (nm), continuously laminated, and a second laminate portion 42 having at least 2 layers of dielectric films 421 (consisting of a high refractive index dielectric film 4H and a low refractive index dielectric film 4L) having a n·d/λ value of from 0.03 to 0.12, continuously laminated. The second infrared reflecting film 5 may have only a first laminate portion 51 having dielectric films 511 (consisting of a high refractive index dielectric film 5H and a low refractive index dielectric film 5L) having a n·d/λ value of from 0.44 to 0.55 where the refractive index is n when the thickness is d (nm) and the wavelength is λ (nm), laminated.

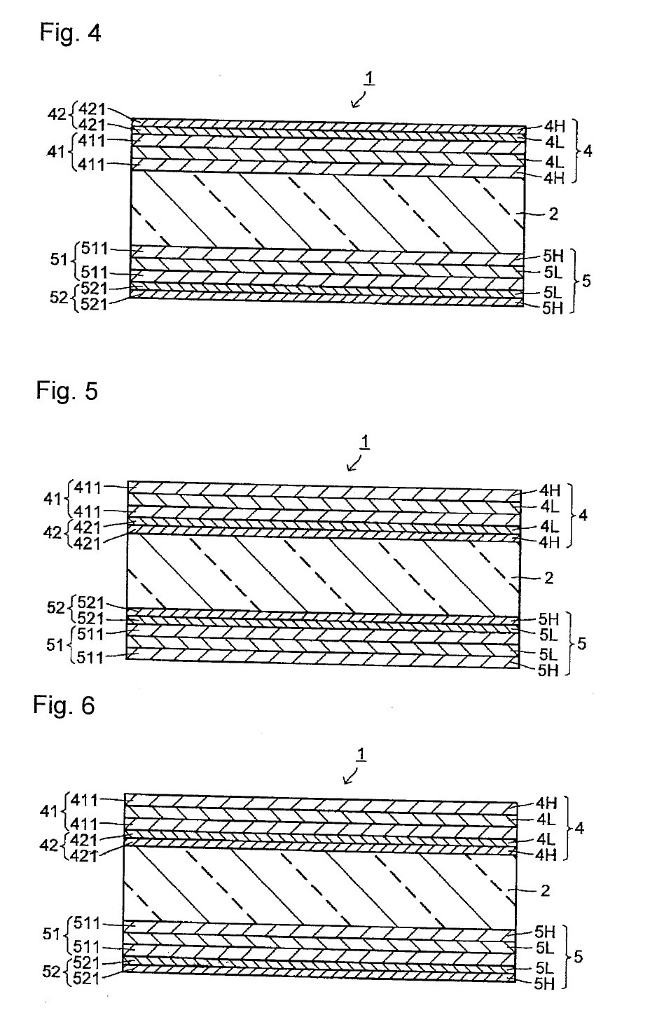

The infrared reflecting film 5 according to the second embodiment may, for example, as shown in FIG. 4 illustrating a modified example of the embodiment as shown in FIG. 3, have a first laminate portion 51 having at least 3 layers of dielectric films 511 having a n·d/λ value of from 0.44 to 0.55 continuously laminated, on one main surface of the transparent substrate 2, and a second laminate portion 52 having 2 layers of dielectric films 521 having a n·d/λ value of from 0.03 to 0.12 continuously laminated, on the first laminate portion 51. The infrared reflecting substrate 1 according to the second embodiment should be such that at least the first infrared reflecting film 4 has the second laminate portion 42, or the second infrared reflecting film 5 has the second laminate portion 52.

With respect to the infrared reflecting substrate 1 with the second laminate portions 42 and 52, the first laminate portion 41 may be formed on one main surface side of the transparent substrate 2 and the first laminate portion 51 is formed on the other main surface side of the transparent substrate 2 as shown in FIG. 4, the second laminate portion 42 may be formed on one main surface side of the transparent substrate 2 and the second laminate portion 52 is formed on the other main surface side of the transparent substrate 2 as shown in FIG. 5 for example, or the first laminate portion 51 may be formed on one main surface side of the transparent substrate 2 and the second laminate portion 52 is formed thereon, and the second laminate portion 42 is formed on the other main surface side of the transparent substrate 2 and the first laminate portion 41 is formed thereon, as shown in FIG. 6 for example.

The infrared reflecting substrate 1 according to the second embodiment is characterized by having the infrared reflecting films 4 and 5 on both the main surfaces of the transparent substrate 2 as mentioned above. With respect to such an infrared reflecting substrate 1 having the infrared reflecting film 4 and 5 on both the main surfaces, totally at least 5 layers of the dielectric film 4H and the dielectric film 4L are laminated, or totally at least 5 layers of the dielectric film 5H and the dielectric film 5L are laminated. The numbers of layers in the infrared reflecting films 4 and 5 are usually preferably the same, but may be different from each other.

If the number of layers in at least one of the infrared reflecting films 4 and 5 is less than 5, the visible light transmittance or the reflectance in the near infrared region when formed into a laminated glass may be insufficient. The number of layers in each of the infrared reflecting films 4 and 5 is not necessarily limited so long as it is at least 5, but if it exceeds 9, the decrease in productivity due to an increase in the production steps tends to be remarkable, and accordingly, with a view to satisfying both the optical properties and the productivity, it is usually preferably from 5 to 9, more preferably from 5 to 7.

The first laminate portions 41 and 51 respectively mainly constitute the infrared reflecting films 4 and 5, and are provided to obtain favorable optical properties when formed into a laminated glass. Each of the first laminate portions 41 and 51 is constituted by at least 3 layers of dielectric films 411 (consisting of the high refractive index dielectric film 4H and the low refractive index dielectric film 4L) or dielectric films 511 (consisting of the high refractive index dielectric film 5H and the low refractive index dielectric film 5L), having a n·d/λ value of from 0.44 to 0.55, continuously laminated. In a case where the second laminate portion 42 or 52 is not formed, the first laminate portion 41 or 51 on the side where it is not formed, has at least 5 layers continuously laminated.

If the n·d/λ value of the dielectric films 411 and 511 is less than 0.44 or exceeds 0.55, the visible light transmittance, the reflectance in the near infrared region and the like when formed into a laminated glass may be insufficient. The n·d/λ value of the dielectric films 411 and 511 is preferably from 0.44 to 0.53, more preferably from 0.45 to 0.52. Further, if the number of layers of the dielectric films 411 or 511 is less than 3, the visible light transmittance, the reflectance in the near infrared region and the like when formed into a laminated glass may be insufficient.

Here, the dielectric films 411 and the dielectric films 511 may have different n·d/λ values. Further, the respective dielectric films 411, and the respective dielectric films 511, may have different n·d/λ values. However, usually, the first laminate portion 41 and the first laminate portion 51 are preferably the same, for example, the dielectric film 4H constituting the dielectric film 411 and the dielectric film 5H constituting the dielectric film 511 preferably have the same or substantially the same n·d/λ value, and the dielectric film 4L constituting the dielectric film 411 and the dielectric film 5L constituting the dielectric film 511 preferably have the same or substantially the same n d/λ value. The position of the disposition of the first laminate portion 41 and the second laminate portion 51 may be different as shown in FIG. 6 for example.

On the other hand, the second laminate portions 42 and 52 are provided mainly to make the color tone on the surface when formed into a laminate glass favorable. Each of the second laminate portions 42 and 52 is constituted by at least 2 layers of dielectric films 421 or 521 (consisting of a high refractive index dielectric film 4H or 5H and a low refractive index dielectric film 4L or 5L) having a n·d/λ value of from 0.03 to 0.12, continuously laminated. As mentioned above, the second laminate portion 42 or 52 is formed on at least one of the main surface and the other surface of the transparent substrate 2.

If the n·d/λ value of the dielectric films 421 or 521 is less than 0.03 or exceeds 0.12, when formed into a laminated glass, its surface may have an excessively reddish stimulus color tone. The n·d/λ value of the dielectric films 421 and 521 is preferably from 0.03 to 0.11, more preferably from 0.04 to 0.10. Further, if the number of layers of the dielectric films 421 or 521 is less than 2, when formed into a laminated glass, its surface may have, for example, an excessively reddish stimulus color tone. On the other hand, if the number of layers of the dielectric films 421 or 521 exceeds 2, when formed into a laminated glass, the color tone on its surface will not be influenced, but the increase in the number of layers will lead to a decrease in the productivity.

The dielectric films 421 and the dielectric films 521 may have different n·d/λ values. Further, the respective dielectric films 421, and the respective dielectric films 521, may have different n·d/λ values. However, usually, the second laminate portion 42 and the second laminate portion 52 are preferably the same, for example, the dielectric film 4H constituting the dielectric film 421 and the dielectric film 5H constituting the dielectric film 521 preferably have the same or substantially the same n·d/λ value, and the dielectric film 4L constituting the dielectric film 421 and the dielectric film 5L constituting the dielectric film 521 preferably have the same or substantially the same n·d/λ value.

The infrared reflecting substrate 1 according to the second embodiment can be produced basically in the same manner as the infrared reflecting substrate 1 according to the first embodiment except that the infrared reflecting films 4 and 5 are formed on both surfaces of the transparent substrate 2. With respect to the infrared reflecting substrate 1 according to the second embodiment also, favorable optical properties and color tone when formed into a laminated glass can be achieved in the same manner as the infrared reflecting substrate 1 according to the first embodiment, and a substantial change in the design film thickness from the conventional design can be suppressed, whereby a favorable productivity is achieved. Particularly, according to the infrared reflecting substrate 1 according to the second embodiment, deformation such as warpage at the time of producing the substrate can be suppressed, since the infrared reflecting films 4 and 5 are formed on both surfaces of the transparent substrate 2.

Now, the laminated glass of the present invention will be described.

First, a laminated glass according to a first embodiment of the present invention will be described.

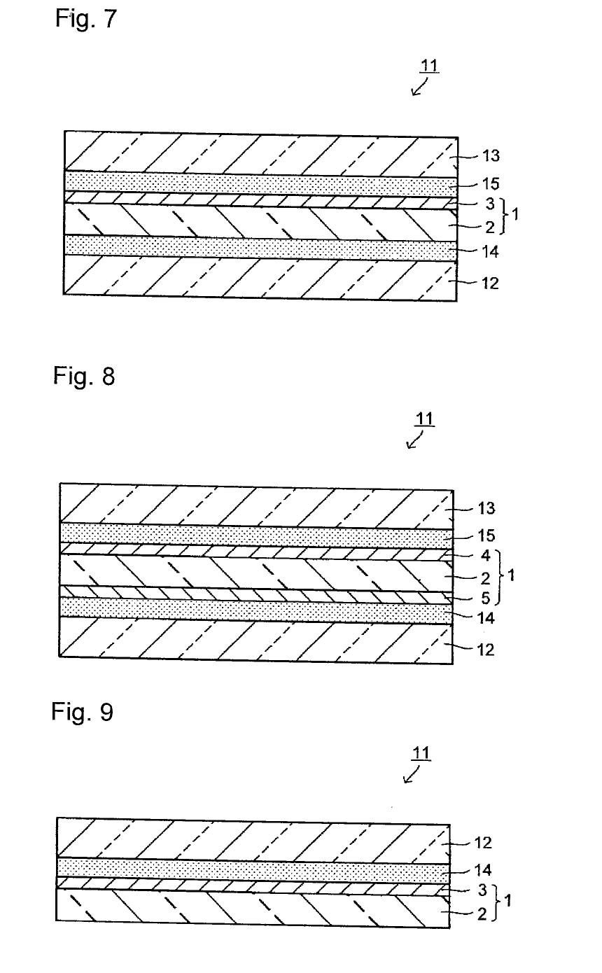

FIG. 7 is a cross-sectional view illustrating one example of the laminated glass according to the first embodiment.

A laminated glass 11 according to the first embodiment comprises, for example, a pair of facing glass substrates 12 and 13, an infrared reflecting substrate 1 according to the first embodiment disposed between the pair of glass substrates 12 and 13, and a pair of bonding layers 14 and 15 disposed between the pair of glass substrates 12 and 13 and the infrared reflecting substrate 1. The first laminated glass 11 may be one using the infrared reflecting substrate 1 according to the second embodiment as shown in FIG. 8 for example.

The infrared reflecting substrate 1 according to the first or second embodiment is usually one wherein the transparent substrate 2 is made of a transparent resin film. With respect to the infrared reflecting substrate 1 according to the first or second embodiment, either of both the main surfaces may be disposed on the light beam incident side, and in the case of one having the infrared reflecting film 3 only on one main surface side such as the infrared reflecting substrate 1 according to the first embodiment, the main surface side with the infrared reflecting film 3 is preferably disposed to the light beam incident side of the laminated glass.

Now, the laminated glass according to a second embodiment of the present invention will be described.

FIG. 9 is a cross-sectional view illustrating one example of the laminated glass according to the second embodiment.

A laminated glass 11 according to the second embodiment comprises an infrared reflecting substrate 1 according to the first embodiment, a glass substrate 12 disposed to face the infrared reflecting film 3 side of the infrared reflecting substrate 1 according to the first embodiment, and a bonding layer 14 disposed between the infrared reflecting substrate 1 according to the first embodiment and the glass substrate 12.

According to the laminated glass 11 according to the second embodiment, which does not require two glass substrates 12 and 13 as in the laminated glass 11 according to the first embodiment, a favorable productivity can be achieved. The infrared reflecting substrate 1 according to the first embodiment is usually one wherein the transparent substrate 2 is a glass plate. Further, with respect to the laminated glass 11 according to the second embodiment, either one of the main surface side on which the infrared reflecting substrate 1 according to the first embodiment is formed and the main surface side on which the glass substrate 12 is disposed may be disposed on the light beam incident side.

Members to be used for the laminated glasses 11 according to the first and second embodiments are basically the same. The bonding layers 14 and 15 are formed to bond the glass substrates 12 and 13 and the infrared reflecting substrate 1, and are made of a thermoplastic resin composition containing a thermoplastic resin as the main component for example. The thickness of each of the bonding layers 14 and 15 is not necessarily limited, and for example, it is preferably from 0.1 to 1.5 mm, more preferably from 0.2 to 1.0 mm.

The thermoplastic resin may be a thermoplastic resin which has been used for such an application, such as a plasticized polyvinyl acetal resin, a plasticized polyvinyl chloride resin, a saturated polyester resin, a plasticized saturated polyester resin, a polyurethane resin, a plasticized polyurethane resin, an ethylene/vinyl acetate copolymer resin or an ethylene/ethyl acrylate copolymer resin.

Among them, a plasticized polyvinyl acetal resin may be mentioned as a preferred example in view of excellent balance of various properties such as transparency, weather resistance, strength, bonding strength, penetration resistance, impact energy absorptivity, moisture resistance, heat shielding properties and sound insulating properties. Such thermoplastic resins may be used alone or in combination of two or more. The “plasticized” of the plasticized polyvinyl acetal resin means that the resin is plasticized by addition of a plasticizer for example. The same applies in some cases to other plasticized resins. Of course, when the resin itself is thermoplastic, addition of a plasticizer is not necessary in some cases.

The polyvinyl acetal resin may, for example, be a polyvinyl formal resin obtainable by reacting polyvinyl alcohol (hereinafter referred to as “PVA” as the case requires) with formaldehyde, a narrowly-defined polyvinyl acetal resin obtainable by reacting PVA with acetaldehyde, or a polyvinyl butyral resin (hereinafter referred to as “PVB” as the case requires) obtainable by reacting PVA with n-butylaldehyde, and PVB may be mentioned as a preferred example, in view of excellent balance of various properties such as transparency, weather resistance, strength, bonding strength, penetration resistance, impact energy absorptivity, moisture resistance, heat insulating properties and sound insulating properties. Such polyvinyl acetal resins may be used alone or in combination of two or more.

PVA to be used for preparation of a polyvinyl acetal resin is usually preferably one having an average degree of polymerization of from 200 to 5,000, more preferably from 500 to 3,000. Further, the polyvinyl acetal resin is usually preferably one having a degree of acetalization of from 40 to 85 mol %, more preferably from 50 to 75 mol %, and is preferably one having a remaining acetyl group amount of at most 30 mol %, more preferably from 0.5 to 24 mol %.

The plasticizer may, for example, be an organic ester type plasticizer such as a monobasic organic ester type or a polybasic organic ester type, or a phosphate type plasticizer such as an organic phosphate type or an organic phosphite type. The amount of addition of the plasticizer varies depending upon the average degree of polymerization of the thermoplastic resin, or the average degree of polymerization, the degree of acetalization or the remaining acetyl group amount of the polyvinyl acetal resin, but is preferably from 10 to 80 parts by mass per 100 parts by mass of the thermoplastic resin. If the amount of addition of the plasticizer is less than 10 parts by mass, plasticization of the thermoplastic resin tends to be insufficient, whereby forming may be difficult. Further, if the amount of addition of the plasticizer exceeds 80 parts by mass %, the strength may be insufficient.

In the thermoplastic resin composition, an infrared shielding agent may be incorporated. The infrared shielding agent may, for example, be inorganic fine particles of a metal such as Re, Hf, Nb, Sn, Ti, Si, Zn, Zr, Fe, Al, Cr, Co, Ce, In, Ni, Ag, Cu, Pt, Mn, Ta, W, V or Mo, an oxide, nitride, sulfide or silicon compound thereof, or such a compound doped with a dopant such as Sb, F or Sn, specifically, Sb-doped tin oxide fine particles (ATO fine particles) or Sn-doped indium oxide fine particles (ITO fine particles, and among them, ITO fine particles may be mentioned as a suitable example.

The ITO fine particles are preferably one having an average particle size of primary particles of at most 100 nm. If the average particle size of the ITO fine particles exceeds 100 nm, the transparency may be insufficient. Further, the content of the ITO fine particles is preferably from 0.1 to 3.0 parts by mass, more preferably from 0.1 to 1.0 part by mass per 100 parts by mass of the thermoplastic resin. If the content of the ITO fine particles is less than 0.1 part by mass, sufficient infrared shielding properties will not necessarily be obtained, and if it exceeds 3.0 parts by mass, the visible light transmittance may be insufficient.

Further, in the thermoplastic resin composition, in addition to the thermoplastic resin and the infrared shielding agent incorporated as the case requires, one or more of various additives such as an adhesion adjusting agent, a coupling agent, a surfactant, an antioxidant, a thermal stabilizer, a photostabilizer, an ultraviolet absorber, a fluorescent agent, a dehydrating agent, a defoaming agent, an antistatic agent and a flame retardant may be incorporated.

In a case where the infrared shielding agent is incorporated in the bonding layer 14 or 15, the infrared shielding agent is preferably incorporated particularly in the bonding layer on the light beam exit side of the infrared reflecting substrate 1, whereby favorable optical properties of the laminated glass 11 are likely to be obtained.

As the glass substrates 12 and 13, a known glass plate may be mentioned, such as an inorganic transparent glass plate such as a clear glass plate, a green glass plate or a UV green glass plate, or a so-called organic transparent glass plate such as a polycarbonate plate or a polymethyl methacrylate plate.

Particularly, the glass substrate on the light beam exit side of the infrared reflecting substrate 1 of the glass substrates 12 and 13 is preferably a UV green glass plate, whereby favorable optical properties of the laminated glass 11 are likely to be obtained.

Further, one which has the same function as the glass substrates 12 and 13, i.e. the transparent substrate 2 (made of a glass plate) of the infrared reflecting substrate 1 according to the first embodiment as shown in FIG. 9, is also preferably a UV green glass plate, when it is disposed on the light beam exit side.

Here, a UV green glass plate means ultraviolet absorbing green glass comprising from 68 to 74 mass % of SiO₂, from 0.3 to 1.0 mass % of Fe₂O₃ and from 0.05 to 0.5 mass % of FeO as calculated as oxides, having an ultraviolet transmittance at a wavelength of 350 nm of at most 1.5% and having a local minimum of the transmittance within a range of from 550 to 1,700 nm.

The thickness of the glass substrates 12 and 13 is not necessarily limited, and is preferably from 1 to 4 mm, more preferably from 1.8 to 2.5 mm. The glass substrates 12 and 13 may be coated to impart a water repellent function, a hydrophilic function, an antifogging function or the like.

Of the laminated glass 11 of the present invention, when a light beam vertically enters the surface, for example, the above-mentioned surface on the light beam incident side, is defined as the light beam incident angle of 0°, the chromaticity in accordance with the chromaticity coordinate as specified by JIS Z8701 on the surface when the light beam incident angle is 0° is preferably within a range of x=0.31±0.02 and y=0.31±0.02. Further, when the light beam incident angle is 70°, the chromaticity is preferably within a range of x=0.31±0.02 and y=0.31±0.02. The light beam incident angle of 70° is employed assuming a case where the laminated glass is used as a windshield of an automobile. Within the above-mentioned chromaticity range, a laminated glass having a favorable neutral color tone without a stimulus color tone can be obtained, and such a laminated glass is optimum as a window glass for an automobile or another vehicle, particularly as a windshield.

Further, of the laminated glass 11 of the present invention, the solar reflectance (Re) is preferably at least 28%, the visible light transmittance (Tv) is preferably at least 70%, and the visible light reflectance (Rv) is preferably at most 12%, as specified by JIS R3106-1998. In order to achieve such values, it is preferred that the infrared shielding agent is incorporated in the bonding layer on the light beam exit side of the infrared reflecting substrate 1 between the bonding layers 14 and 15 as mentioned above, and that the glass substrate on the light beam exit side of the infrared reflecting substrate 1 between the glass substrates 12 and 13 is a UV green glass plate.

The laminated glass 11 of the present invention has favorable optical properties, particularly a favorable color tone on its surface, and is thereby suitably used as a window material for an automobile, a railway vehicle, shipping or a building material, particularly as a windshield for an automobile. Such a laminated glass 11 can be produced in the same manner as a conventional laminated glass except that the infrared reflecting substrate 1 is used.

For example, a laminated glass as shown in FIG. 7 can be produced, for example, by laminating a glass substrate 12, an adhesive sheet (bonding layer 14), an infrared reflecting substrate 1, an adhesive sheet (bonding layer 15) and a glass substrate 13 in this order to form a laminate, followed by pre-bonding and main bonding of the laminate.

Otherwise, it may be produced, for example, by laminating an adhesive sheet (bonding layer 14), an infrared reflecting substrate 1 and an adhesive sheet (bonding layer 15) in this order, followed by pressurization under heating at a temperature of from 40 to 80° C. under a pressure of from 0.1 to 1.0 MPa to form a pre-laminate, and laminating glass substrates 12 and 13 on both the main surfaces of the pre-laminate to form a laminate, followed by pre-bonding and main bonding of the laminate.

Pre-bonding is carried out for the purpose of deaerating the space between constituting members, and is carried out, for example, by putting the laminate in a vacuum bag such as a rubber bag connected to an evacuation system, and holding it at from 70 to 130° C. for from 10 to 90 minutes with deaeration so that the pressure in the vacuum bag becomes at most 100 kPa, preferably from about 1 to about 36 kPa.

The pre-bonding can be sufficiently carried out by setting the temperature to be at least 70° C. On the other hand, by setting the temperature to be at most 130° C., cracking due to excessive heat shrinkage of the infrared reflecting substrate 1 will be suppressed. With a view to carrying out the pre-bonding more effectively, the temperature is preferably at least 90° C., more preferably at least 110° C.

Further, by setting the time to be at least 10 minutes, the pre-bonding can be sufficiently carried out. Further, by setting the time to be at most 90 minutes, a decrease in the productivity can be suppressed, and cracking due to excessive heat shrinkage of the infrared reflecting substrate 1 can be suppressed. The time is preferably from 20 to 60 minutes with a view to carrying out the pre-bonding more effectively and efficiently.

Main bonding is carried out to sufficiently bond the glass substrates 12 and 13 and the infrared reflecting substrate 1 by the adhesive sheets (bonding layers 12 and 13), by putting the pre-bonded product obtained by the pre-bonding in an autoclave at a temperature of from 120 to 150° C. under a pressure of from 0.98 to 1.47 MPa. The main bonding is more preferably carried out at a temperature of from 130 to 140° C. under a pressure of from 1.1 to 1.4 MPa. Further, the time is preferably from 30 to 90 minutes, more preferably from 45 to 75 minutes. When the temperature, the pressure and the time for the main bonding are within the above ranges, sufficient bonding can be conducted. Further, cracking due to excessive heat shrinkage of the infrared reflecting substrate 1 can be suppressed, and a favorable productivity and the like are obtained.

### EXAMPLES

### Example 1

An infrared reflecting substrate having a constitution as shown in Table 1 (cells surrounded by bold lines) was produced. In Table, values in cells surrounded by the bold lines represent the thicknesses of the films, and their unit is (nm). Further, the n·d/λ values are as shown in Table 4.

As a transparent substrate, a PET film of 100 mm×100 mm×100 μm in thickness, having an adhesive layer (PET (TR) in Table) provided on a PET film main body (PET in Table) was used. This PET film was set in a sputtering apparatus, and 9 layers of a high refractive index dielectric film (TiO₂ film) and a low refractive index dielectric film (SiO₂ film) were alternately laminated to have a predetermined thickness to form an infrared reflecting film on the surface of the PET film by a magnetron sputtering method, thereby to obtain an infrared reflecting substrate.

Each TiO₂ film was formed by using a Ti target, by introducing 1,000 W of microwaves to a vacuum chamber by an ECR oxidation source while introducing 2,500 sccm of argon as an inert gas and 700 sccm of an oxygen gas as a reactive gas to an oxidation zone and rotating a drum on which the PET film was set at 150 rpm, and applying 15 kW of an AC power. On that occasion, the pressure in the chamber was 0.58 Pa.

On the other hand, each SiO₂ film was formed by using a Si target by introducing 1,000 W of microwaves into the vacuum chamber by an ECR oxidation source while introducing 2,500 sccm of an argon gas and 900 sccm of an oxygen gas and rotating the drum on which the PET film was set at 150 rpm, and applying 15 kW of an AC power. On that occasion, the pressure in the chamber was 0.55 Pa. The thickness of the dielectric films was adjusted by changing the film formation time.

Using this infrared reflecting substrate, a laminated glass having a structure shown in Table 1 was produced. That is, as a glass substrate on the light beam incident side (upper side in Table), transparent soda lime glass (FL in Table) of 100 mm×100 mm×2 mm in thickness was used. As a glass substrate on the light beam exit side (the lower side in Table), a UV green glass plate (UVFL in Table) of the same size and thickness, which cuts off the UV wavelength, was used. As the adhesive sheet (bonding layer) on the light beam incident side, a PVB film (PVB (CL) in Table) having a thickness of 0.38 mm containing no infrared shielding agent was used. As an adhesive sheet (bonding layer) on the light beam exit side, a PVB film (PVB (IR cut) in Table, manufactured by Asahi Glass Company, Limited, tradename: Cool verre) containing an infrared shielding agent was used.

They were laminated to form a laminate, which was put in a vacuum bag, and heated at 120° C. for 30 minutes with deaeration so that the pressure in the vacuum bag became about 100 kPa or below to obtain a pre-bonded product. Further, this pre-bonded product was put in an autoclave and pressurized under heating at a temperature of 135° C. under a pressure of 1.3 MPa for 60 minutes to carry out the main bonding thereby to obtain a laminated glass.

### Example 2

An infrared reflecting substrate was produced substantially in the same manner as in Example 1 except that the SiO₂ films were changed to MgF₂ films as shown in Table 1. Each MgF₂ film was formed by a vacuum deposition method using an EB deposition source disposed in the same apparatus. Using the infrared reflecting substrate, a laminated glass was produced substantially in the same manner as in Example 1.

### Example 3

As shown in Table 1, a TiO₂ film and a SiO₂ film were alternately laminated on the opposite side of the PET film from the adhesive layer to form an infrared reflecting film, thereby to produce an infrared reflecting substrate. Using this infrared reflecting substrate so that the PET film side becomes the light beam incident side, a laminated glass was produced substantially in the same manner as in Example 1.

### Examples 4 to 10

As shown in Table 1, a TiO₂ film and a SiO₂ film were alternately laminated directly on soda lime glass (FL) or a UV green glass plate (UVFL) to form an infrared reflecting film, thereby to produce an infrared reflecting substrate. On this infrared reflecting substrate, soda lime glass (FL) or a UV green glass plate (UVFL) was disposed via a PVB film (PVB(CL)) containing no infrared shielding agent, followed by the pre-bonding and the main bonding substantially in the same manner as in Example 1 to produce a laminated glass.

### Examples 11 to 16

As shown in Table 2, on both sides of a PET film, a TiO₂ film and a SiO₂ film were alternately laminated to form an infrared reflecting film, thereby to produce an infrared reflecting substrate. Further, using this infrared reflecting substrate, a laminated glass was produced substantially in the same manner as in Example 1.

### Comparative Examples 1 and 2

As shown in Table 3, on one side of a PET film having an adhesive layer, a TiO₂ film and a SiO₂ film were alternately laminated to form an infrared reflecting film, thereby to produce an infrared reflecting substrate. Further, using this infrared reflecting substrate, a laminated glass was produced substantially in the same manner as in Example 1.

Then, with respect to the laminated glasses in Examples and Comparative Examples, the solar reflectance (Re), the visible light transmittance (Tv) and the visible light reflectance (Rv) as specified by JIS R3106-1998, and the chromaticity (x,y) (angle: 0° or 70°) as specified by JIS Z8701 were measured. The results are shown in Tables 1 to 3.

TABLE 1

| | Ex. 1 | | Ex. 2 | | Ex. 3 | | Ex. 4 | | Ex. 5 | |
|---|---|---|---|---|---|---|---|---|---|---|
| Consti- | One side | | One side | | One side | | Directly | | Directly | |
| tution | on PET | | on PET | | on PET | | on glass | | on glass | |
| 15 | FL | | FL | | FL | | | | | |
| 14 | PVB(CL) | | PVB(CL) | | PVB(CL) | | | | | |
| 13 | TiO₂ | 17 | TiO₂ | 10 | PET(TR) | | | | | |
| 12 | SiO₂ | 30 | MgF₂ | 25 | PET | | FL | | FL | |
| 11 | TiO₂ | 95 | TiO₂ | 99 | TiO₂ | 95 | PVB(CL) | | PVB(CL) | |
| 10 | SiO₂ | 160 | MgF₂ | 185 | SiO₂ | 160 | TiO₂ | 17 | TiO₂ | 95 |
| 9 | TiO₂ | 95 | TiO₂ | 99 | TiO₂ | 95 | SiO₂ | 30 | SiO₂ | 160 |
| 8 | SiO₂ | 160 | MgF₂ | 185 | SiO₂ | 160 | TiO₂ | 95 | TiO₂ | 95 |
| 7 | TiO₂ | 95 | TiO₂ | 99 | TiO₂ | 95 | SiO₂ | 160 | SiO₂ | 160 |
| 6 | SiO₂ | 160 | MgF₂ | 185 | SiO₂ | 160 | TiO₂ | 95 | TiO₂ | 95 |
| 5 | TiO₂ | 95 | TiO₂ | 99 | TiO₂ | 95 | SiO₂ | 160 | SiO₂ | 160 |

| | | | | | | | | |
|---|---|---|---|---|---|---|---|---|
| 4 | PET | PET | SiO₂ | 30 | TiO₂ | 95 | TiO₂ | 95 |
| 3 | PET(TR) | PET(TR) | TiO₂ | 17 | SiO₂ | 160 | SiO₂ | 30 |

| | | | | | | | |
|---|---|---|---|---|---|---|---|
| 2 | PVB | PVB | PVB | TiO₂ | 95 | TiO₂ | 17 |
| | (IR cut) | (IR cut) | (IR cut) | | | | |

| 1 | | UVFL | UVFL | UVFL | FL | FL |
|---|---|---|---|---|---|---|
| Re [%] | | 30 | 30 | 30 | 31 | 31 |
| Tv [%] | | 77 | 77 | 76 | 87 | 86 |
| Rv [%] | | 11 | 11 | 11 | 11 | 12 |
| Chroma- | x | 0.306 | 0.306 | 0.306 | 0.306 | 0.311 |
| ticity | y | 0.307 | 0.307 | 0.308 | 0.305 | 0.313 |
| (0°) | | | | | | |
| Chroma- | x | 0.320 | 0.320 | 0.320 | 0.295 | 0.320 |
| ticity | y | 0.292 | 0.292 | 0.290 | 0.320 | 0.296 |
| (70°) | | | | | | |

| | Ex. 6 | | Ex. 7 | | Ex. 8 | | Ex. 9 | | Ex. 10 | |
|---|---|---|---|---|---|---|---|---|---|---|
| Consti- | Directly | | Directly | | Directly | | Directly | | Directly | |
| tution | on glass | | on glass | | on glass | | on glass | | on glass | |
| 15 | | | | | | | | | | |
| 14 | | | | | | | | | | |
| 13 | | | | | | | | | | |
| 12 | FL | | FL | | FL | | FL | | FL | |
| 11 | PVB(CL) | | TiO₂ | 17 | TiO₂ | 95 | TiO₂ | 17 | TiO₂ | 95 |
| 10 | TiO₂ | 17 | SiO₂ | 30 | SiO₂ | 160 | SiO₂ | 30 | SiO₂ | 160 |
| 9 | SiO₂ | 30 | TiO₂ | 95 | TiO₂ | 95 | TiO₂ | 95 | TiO₂ | 95 |
| 8 | TiO₂ | 95 | SiO₂ | 160 | SiO₂ | 160 | SiO₂ | 160 | SiO₂ | 160 |
| 7 | SiO₂ | 160 | TiO₂ | 95 | TiO₂ | 95 | TiO₂ | 95 | TiO₂ | 95 |
| 6 | TiO₂ | 95 | SiO₂ | 160 | SiO₂ | 160 | SiO₂ | 160 | SiO₂ | 160 |
| 5 | SiO₂ | 160 | TiO₂ | 95 | TiO₂ | 95 | TiO₂ | 95 | TiO₂ | 95 |
| 4 | TiO₂ | 95 | SiO₂ | 160 | SiO₂ | 30 | SiO₂ | 160 | SiO₂ | 30 |
| 3 | SiO₂ | 160 | TiO₂ | 95 | TiO₂ | 17 | TiO₂ | 95 | TiO₂ | 17 |

| | | | | | | |
|---|---|---|---|---|---|---|
| 2 | TiO₂ | 95 | PVB(CL) | PVB(CL) | PVB(CL) | PVB(CL) |

| 1 | | UVFL | FL | FL | UVFL | UVFL |
|---|---|---|---|---|---|---|
| Re [%] | | 30 | 32 | 32 | 32 | 31 |
| Tv [%] | | 79 | 86 | 87 | 78 | 79 |
| Rv [%] | | 11 | 12 | 11 | 11 | 11 |
| Chroma- | x | 0.305 | 0.310 | 0.305 | 0.310 | 0.304 |
| ticity | y | 0.307 | 0.312 | 0.303 | 0.314 | 0.305 |
| (0°) | | | | | | |
| Chroma- | x | 0.320 | 0.319 | 0.318 | 0.320 | 0.319 |
| ticity | y | 0.294 | 0.294 | 0.293 | 0.292 | 0.292 |
| (70°) | | | | | | |

TABLE 2

| | Ex. 11 | | Ex. 12 | | Ex. 13 | | Ex. 14 | | Ex. 15 | | Ex. 16 | |
|---|---|---|---|---|---|---|---|---|---|---|---|---|
| Constitution | Both sides | | Both sides | | Both sides | | Both sides | | Both sides | | Both sides | |
| | on PET | | on PET | | on PET | | on PET | | on PET | | on PET | |
| 17 | | | | | | | | | | | FL | |
| 16 | | | | | | | | | | | PVB(CL) | |
| 15 | FL | | FL | | FL | | FL | | FL | | TiO₂ | 10 |
| 14 | PVB(CL) | | PVB(CL) | | PVB(CL) | | PVB(CL) | | PVB(CL) | | SiO₂ | 30 |
| 13 | TiO₂ | 17 | TiO₂ | 10 | TiO₂ | 105 | TiO₂ | 105 | TiO₂ | 10 | TiO₂ | 103 |
| 12 | SiO₂ | 30 | SiO₂ | 34 | SiO₂ | 180 | SiO₂ | 180 | SiO₂ | 30 | SiO₂ | 180 |
| 11 | TiO₂ | 95 | TiO₂ | 105 | TiO₂ | 105 | TiO₂ | 105 | TiO₂ | 103 | TiO₂ | 103 |
| 10 | SiO₂ | 160 | SiO₂ | 180 | SiO₂ | 34 | SiO₂ | 34 | SiO₂ | 180 | SiO₂ | 180 |
| 9 | TiO₂ | 95 | TiO₂ | 105 | TiO₂ | 10 | TiO₂ | 10 | TiO₂ | 103 | TiO₂ | 103 |
| 8 | PET | | PET | | PET | | PET | | PET | | PET | |
| 7 | TiO₂ | 95 | TiO₂ | 10 | TiO₂ | 105 | TiO₂ | 10 | TiO₂ | 103 | TiO₂ | 103 |
| 6 | SiO₂ | 160 | SiO₂ | 34 | SiO₂ | 180 | SiO₂ | 34 | SiO₂ | 180 | SiO₂ | 180 |
| 5 | TiO₂ | 95 | TiO₂ | 105 | TiO₂ | 105 | TiO₂ | 105 | TiO₂ | 103 | TiO₂ | 103 |
| 4 | SiO₂ | 30 | SiO₂ | 180 | SiO₂ | 34 | SiO₂ | 180 | SiO₂ | 180 | SiO₂ | 30 |
| 3 | TiO₂ | 17 | TiO₂ | 105 | TiO₂ | 10 | TiO₂ | 105 | TiO₂ | 103 | TiO₂ | 10 |

| 2 | | PVB(IR cut) | PVB(IR cut) | PVB(IR cut) | PVB(IR cut) | PVB(IR cut) | PVB(IR cut) |
|---|---|---|---|---|---|---|---|
| 1 | | UVFL | UVFL | UVFL | UVFL | UVFL | UVFL |
| Re [%] | | 30 | 28 | 28 | 29 | 31 | 29 |
| Tv [%] | | 76 | 76 | 77 | 75 | 75 | 77 |
| Rv [%] | | 11 | 11 | 11 | 13 | 12 | 10 |
| Chromaticity | x | 0.322 | 0.302 | 0.301 | 0.308 | 0.302 | 0.301 |
| (0°) | y | 0.293 | 0.305 | 0.308 | 0.317 | 0.303 | 0.295 |
| Chromaticity | x | 0.328 | 0.308 | 0.304 | 0.310 | 0.301 | 0.310 |
| (70°) | y | 0.310 | 0.293 | 0.294 | 0.291 | 0.292 | 0.292 |

TABLE 3

| | Comp. Ex. 1 | Comp. Ex. 2 |
|---|---|---|
| | One side on | One side on |
| Constitution | PET | PET |
| 15 | FL | FL |
| 14 | PVB(CL) | PVB(CL) |

| | | | | |
|---|---|---|---|---|
| 13 | TiO₂ | 30 | TiO₂ | 20 |
| 12 | SiO₂ | 50 | SiO₂ | 20 |
| 11 | TiO₂ | 120 | TiO₂ | 88 |
| 10 | SiO₂ | 200 | SiO₂ | 170 |
| 9 | TiO₂ | 120 | TiO₂ | 88 |
| 8 | SiO₂ | 200 | SiO₂ | 170 |
| 7 | TiO₂ | 120 | TiO₂ | 88 |
| 6 | SiO₂ | 200 | SiO₂ | 170 |
| 5 | TiO₂ | 120 | TiO₂ | 88 |

| | | |
|---|---|---|
| 4 | PET | PET |
| 3 | PET(TR) | PET(TR) |
| 2 | PVB | PVB |
| | (IR cut) | (IR cut) |
| 1 | UVFL | UVFL |
| Re [%] | 25 | 30 |
| Tv [%] | 76 | 75 |
| Rv [%] | 11 | 12 |

| | | | |
|---|---|---|---|
| Chromaticity | x | 0.241 | 0.274 |
| (0°) | y | 0.179 | 0.262 |
| Chromaticity | x | 0.241 | 0.340 |
| (70°) | y | 0.179 | 0.310 |

TABLE 4

| | First laminate portion | | | Second laminate portion | | |
|---|---|---|---|---|---|---|
| | Com- | Thickness | n · | Com- | Thickness | n · |
| | ponent | (nm) | d/λ | ponent | (nm) | d/λ |
| Ex. 1, | TiO₂ | 95 | 0.466 | TiO₂ | 17 | 0.083 |
| 3 to 11 | SiO₂ | 160 | 0.459 | SiO₂ | 30 | 0.086 |
| Ex. 2 | TiO₂ | 99 | 0.485 | TiO₂ | 10 | 0.049 |
| | MgF₂ | 185 | 0.500 | MgF₂ | 25 | 0.068 |
| Ex. 12 | TiO₂ | 105 | 0.515 | TiO₂ | 10 | 0.049 |
| to 14 | SiO₂ | 180 | 0.515 | SiO₂ | 34 | 0.097 |
| Ex. 15 | TiO₂ | 103 | 0.505 | TiO₂ | 10 | 0.049 |
| to 16 | SiO₂ | 180 | 0.515 | SiO₂ | 30 | 0.086 |
| Comp. | TiO₂ | 120 | 0.588 | TiO₂ | 30 | 0.147 |
| Ex. 1 | SiO₂ | 200 | 0.574 | SiO₂ | 50 | 0.143 |
| Comp. | TiO₂ | 88 | 0.431 | TiO₂ | 20 | 0.098 |
| Ex. 2 | SiO₂ | 170 | 0.488 | SiO₂ | 20 | 0.057 |

With respect to the laminated glasses in Examples, the chromaticity on the surface was within a range of x=0.31±0.02 and y=0.31±0.02, and the surface had a color tone practically without any problem. On the other hand, with respect to the laminated glasses in Comparative Examples, the chromaticity on the surface was out of the range of x=0.31±0.02 and y=0.31±0.02, and the surface had a stimulus color tone, such being practically unfavorable.

### INDUSTRIAL APPLICABILITY

According to the infrared reflecting substrate of the present invention, by repeatedly laminating a high refractive index dielectric film and a low refractive index dielectric film in combination of a specific thickness, a laminated glass with a surface having a favorable neutral color tone without stimulus color tone can be provided, and such a laminated glass is useful as a window glass, particularly a windshield, for an automobile and other various vehicles.

### REFERENCE SYMBOLS

1: Infrared reflecting substrate
2: Transparent substrate
3, 4, 5: Infrared reflecting film
3H, 4H, 5H: High refractive index dielectric film
3L, 4L, 5L: Low refractive index dielectric film
31, 41, 51: First laminate portion
32, 42, 52: Second laminate portion
311, 411, 511: Dielectric film having a n·d/λ value of from 0.44 to 0.55
321, 421, 521: Dielectric film having a n·d/λ value of from 0.03 to 0.12
11: Laminated glass
12, 13: Glass substrate
14, 15: Bonding layer

What is claimed is:

1. An infrared reflecting substrate, which comprises a transparent substrate, and an infrared reflecting film having at least 7 layers of a high refractive index dielectric film and a low refractive index dielectric film alternately laminated, formed on one main surface of the transparent substrate,
wherein the infrared reflecting film has a first laminate portion having at least 5 layers of a high refractive index dielectric film and a low refractive index dielectric film having a n·d/λ value of from 0.44 to 0.55 where the refractive index is n when the thickness is d (nm) and the wavelength is λ (nm), continuously laminated, and a second laminate portion having at least 2 layers of a high refractive index dielectric film and a low refractive index dielectric film having a n·d/λ value of from 0.03 to 0.12 continuously laminated.

2. An infrared reflecting substrate, which comprises a transparent substrate, a first infrared reflecting film having at least 5 layers of a high refractive index dielectric film and a low refractive index dielectric film alternately laminated, formed on one main surface of the transparent substrate, and a second infrared reflecting film having at least 5 layers of a high refractive index dielectric film and a low refractive index dielectric film alternately laminated, formed on the other main surface of the transparent substrate,
wherein at least one of the first infrared reflecting film and the second infrared reflecting film has a first laminate portion having at least three layers of a high refractive index dielectric film and a low refractive index dielectric film having a n·d/λ value of from 0.44 to 0.55 where the refractive index is n when the thickness is d (nm) and the wavelength is λ (nm), continuously laminated, and a second laminate portion having at least 2 layers of a high refractive index dielectric film and a low refractive index dielectric film having a n·d/λ value of from 0.03 to 0.12, continuously laminated.

3. The infrared reflecting substrate according to claim 1, wherein in the first laminate portion, the thickness of the high refractive index dielectric film is from 90 to 115 nm, and the thickness of the low refractive index dielectric film is from 150 to 195 nm.

4. The infrared reflecting substrate according to claim 1, wherein in the second laminate portion, the thickness of the high refractive index dielectric film is from 5 to 30 nm, and the thickness of the low refractive index dielectric film is from 10 to 50 nm.

5. The infrared reflecting substrate according to claim 1, wherein the high refractive index dielectric film is made of titanium oxide, and the low refractive index dielectric film is made of silicon oxide or magnesium fluoride.

6. A laminated glass, which comprises a pair of facing glass substrates, an infrared reflecting substrate disposed between the pair of glass substrates, and a pair of bonding layers disposed between the pair of glass substrates and the infrared reflecting substrate,
wherein the infrared reflecting substrate is the infrared reflecting substrate as defined in claim 1, and its transparent substrate is made of a resin film.

7. The laminated glass according to claim 6, wherein the glass substrate of the pair of glass substrates, on the light beam exit side of the infrared reflecting substrate, is a UV green glass plate, and the bonding layer of the pair of bonding layers, on the light beam exit side of the infrared reflecting substrate, contains an infrared shielding agent.

8. A laminated glass, which comprises an infrared reflecting substrate having an infrared reflecting film only on one main surface, a glass substrate disposed to face the infrared reflecting film side of the infrared reflecting substrate, and a bonding layer disposed between the infrared reflecting substrate and the glass substrate,
wherein the infrared reflecting substrate is the infrared reflecting substrate as defined in claim 1, and its transparent substrate is made of a glass plate.

9. The laminated glass according to claim 8, wherein the infrared reflecting substrate is disposed on the light beam exit side, and the glass plate of the infrared reflecting substrate is a UV green glass plate.

10. The laminated glass according to claim 8, wherein the infrared reflecting substrate is disposed on the light beam incident side, the glass substrate is a UV green glass plate, and the bonding layer contains an infrared shielding agent.

11. The laminated glass according to claim 6, wherein when the light beam incident angle to the surface is 0°, the chromaticity in accordance with the chromaticity coordinate as specified by JIS Z8701 on the surface is within a range of x=0.31±0.02 and y=0.31±0.02.

12. The laminated glass according to claim 11, wherein when the above light beam incident angle is 70°, the chromaticity is within a range of x=0.31±0.02 and y=0.31±0.02.

13. Glass for a vehicle, comprising the laminated glass as defined in claim 6, wherein when the light beam incident angle to the surface of the laminated glass is 0°, the chromaticity in accordance with the chromaticity coordinate as specified by JIS Z8701 on the surface is within a range of x=0.31±0.02 and y=0.31±0.02, and when the above light beam incident angle is 70°, the above chromaticity is within a range of x=0.31±0.02 and y=0.31±0.02.
